(19) United States
(12) Patent Application Publication
(10) Pub. No.: US 2025/0308522 A1
(43) Pub. Date: Oct. 2, 2025

(54) SYSTEMS AND METHODS FOR OFFLINE VOICE CONTROL IN AIRCRAFT MANAGEMENT

(71) Applicant: Innovative Avionics LLC, Phoenix, AZ (US)

(72) Inventors: Kyle Price, Dacula, GA (US); Joachim L. Naimer, Ascona (CH)

(73) Assignee: Innovative Avionics LLC, Phoenix, AZ (US)

(21) Appl. No.: 19/085,844

(22) Filed: Mar. 20, 2025

Related U.S. Application Data
(60) Provisional application No. 63/570,015, filed on Mar. 26, 2024.

(51) Int. Cl. G10L 15/22; B64D 43/00; G06F 40/211; G06F 40/289; G06F 40/30; G10L 15/08; G10L 15/16; G10L 15/30

(52) U.S. Cl. CPC G10L 15/22; B64D 43/00; G06F 40/211; G06F 40/289; G06F 40/30; G10L 15/16; G10L 15/30; G10L 2015/088; G10L 2015/223

(57) ABSTRACT

Systems and methods are provided for offline voice control in aircraft management. A computing system can include a processor and a non-transitory computer-readable storage device storing computer-executable instructions. The instructions can be operable to cause the processor to perform operations comprising receiving an audio input; converting the audio input to a textual message; analyzing the textual message with a natural language processing technique to identify an intent; generating a structured command based on the identified intent; and transmitting the structured command to a user device.

### CROSS-REFERENCE TO RELATED APPLICATIONS

This application claims priority to U.S. Provisional Application No. 63/570,015, filed Mar. 26, 2024, which is herein incorporated by reference in its entirety.

### BACKGROUND OF THE DISCLOSURE

Voice recognition technology has seen a surge in development and application in recent years, with its use spanning various industries and applications. One such application is in the field of aviation, where voice recognition can be used to manage and execute aircraft checklists. Aircraft checklists are a series of procedures that pilots follow to ensure the safe operation of an aircraft. These checklists can be extensive and complex, requiring the pilot's full attention and accuracy.

Traditionally, these checklists are manually executed by the pilot or co-pilot, often in a paper-based format. However, this manual process can be time-consuming and prone to human error, especially in high-stress or emergency situations.

In addition, existing voice control systems (e.g., Siri®, Alexa®, etc.) that can act as digital assistances require internet access to function. This removes their ability to function and assist in airline cockpit situations.

### BRIEF DESCRIPTION OF THE FIGURES

FIG. 1 is a block diagram of an example system for offline voice control in aircraft management according to example embodiments of the present disclosure.

FIG. 2 is a flowchart of an example offline voice control process according to example embodiments of the present disclosure.

FIG. 3 is another flowchart of an example offline voice control process according to example embodiments of the present disclosure.

FIGS. 4-9 show example user interfaces within a voice control application according to some embodiments of the present disclosure.

FIG. 10 is a server device that can be used within the system of FIG. 1 according to an embodiment of the present disclosure.

FIG. 11 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure relate to systems and methods for offline voice control in aircraft management. In particular, the disclosed systems and methods can be used to manage and execute aircraft checklists. For example, the disclosed system can utilize a server device with Bluetooth® functionality that resides within the cockpit of an aircraft. The server can perform various voice processing procedures that are particularly applicable to the environment of a cockpit. For example, the server can include acoustic models and machine learning techniques to specially trained to identify verbal commands within noisy environments, such as the cockpit of an aircraft. In addition, the server can include a database of checklists applicable to various types of aircraft. The disclosed system can also include a mobile application that executes on a user device. The device can be communicably coupled to the server device (e.g., via Bluetooth®) such that it receives commands from the server device; the device can then manipulate various user interfaces to display and manage aircraft checklists. In addition, the disclosed system can be used to control a number of systems in aircraft besides checklists, such as activating aircraft lighting, initiating climate control within the aircraft, or enabling the pilot to verbally request to “prepare for taxi,” where the system can trigger the fasten seatbelt lights and activate a pre-takeoff recording.

In some embodiments, the disclosed system can operate in a normal mode and an interactive mode. In normal mode, the server actively monitors received audio inputs (e.g., inputs from the microphone of a headset worn by the pilot) to detect a keyword. Once the keyword has been detected, the mode of the system changes to the interactive mode, where subsequently received audio inputs are analyzed in their entirety. For example, the audio inputs can be analyzed through various processes and transformed into structured commands, which are sent to the user device to manipulate the user interface and checklist contained therein. In addition, in interactive mode, various LED configurations on the server device can be displayed to indicate to the users that the device is actively in an interactive mode.

The disclosed systems and methods offer various benefits, such as reducing the manual workload and stress of pilots and minimizing human error. In particular, the system can enhance the efficiency and accuracy of managing and executing aircraft checklists.

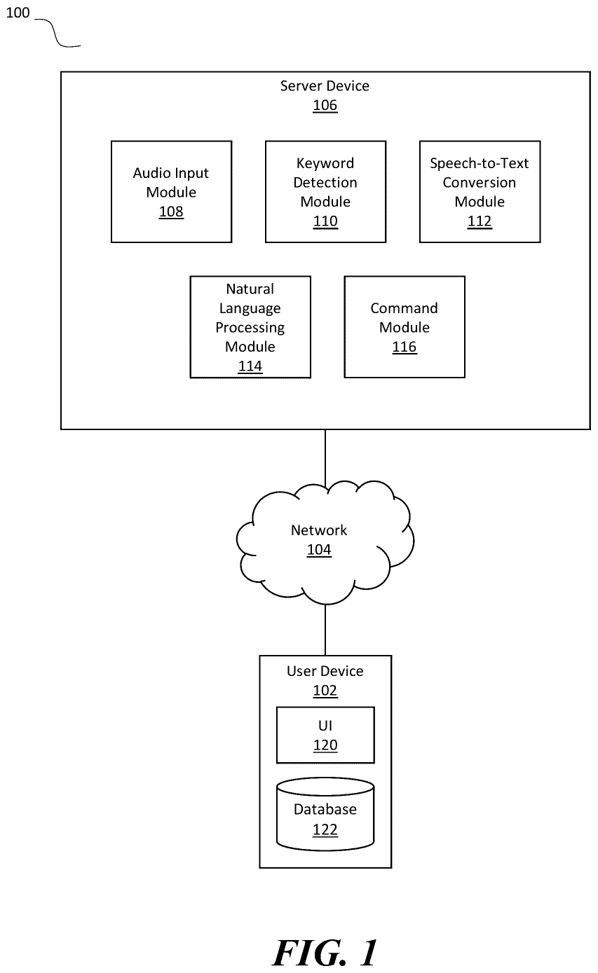

FIG. 1 is a block diagram of an example system 100 for offline voice control in aircraft management according to example embodiments of the present disclosure. The system 100 can include one or more user devices 102 (generally referred to herein as a “user device 102” or collectively referred to herein as “user devices 102”) that can access, via network 104, a server device 106. In some embodiments, the server device 106 and the user device 102 will both reside within the cockpit of an aircraft. For example, the user device 102 can be a mobile device that a pilot uses to execute a checklist. The server device 106 can detect spoken audio from a pilot, perform various processing on the audio and transform it into a command that is transmitted to the user device to manage the checklist and manipulate the user interface (UI) 120. In addition, the user device 102 can include a database 122. In some embodiments, the database 122 is configured to store a plurality of OEM checklists in a digitized format. In some embodiments, the checklists can be associated with specific aircraft types and can be queried by the various modules and user devices described herein. It is important to note, however, that while FIG. 1 shows the database 122 as being part of user device 102, it is also possible for the database 122 to reside on the server 106. In addition, while the system 100 illustrates, in an exemplary manner, that one server 106 and one user device 102 are used, in some embodiments, the system 100 can include multiple user devices 102 operating in communication with the server 106.

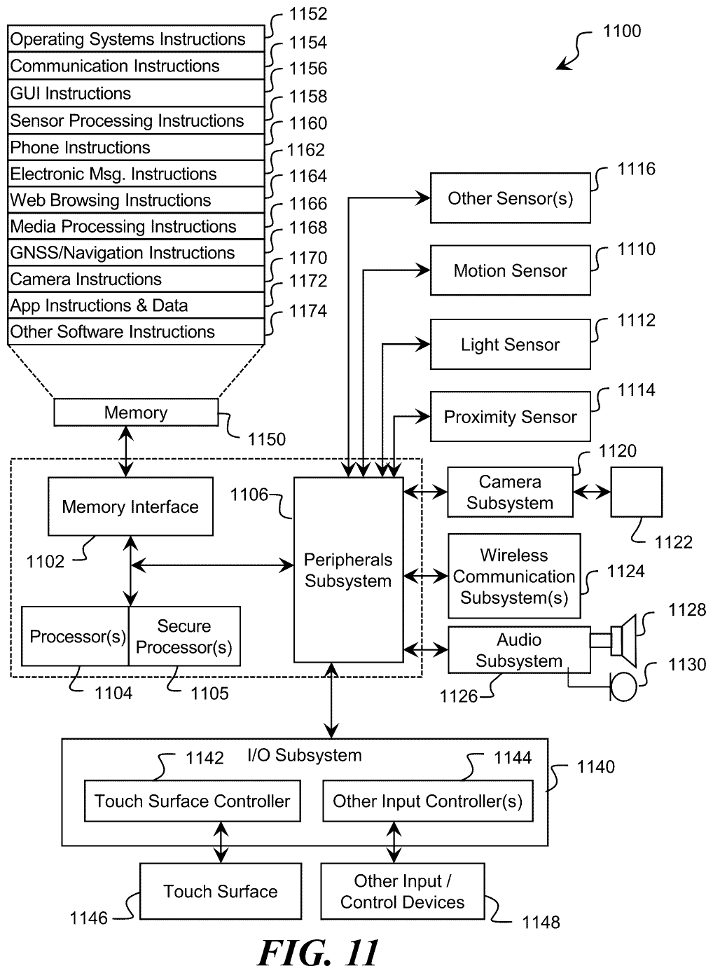

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 1100 described below with respect to FIG. 11.

In some embodiments, the network 104 connecting the user device 102 and the server device 106 can be a Bluetooth Low Energy® (BLE) connection. In addition, in other embodiments, the network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

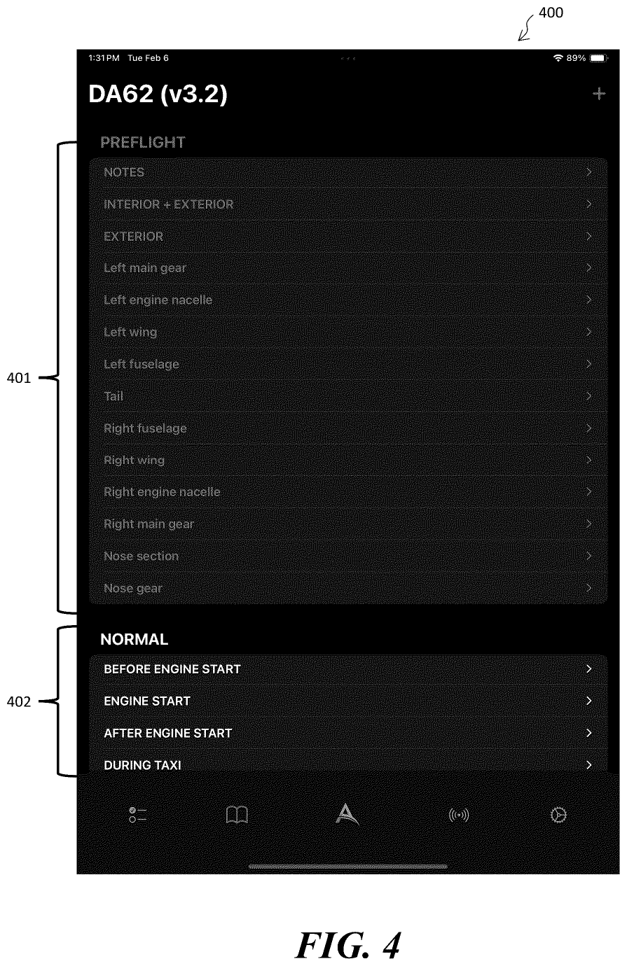

The server 106 may include any combination of one or more of web servers, mainframe computers, general-purpose computers, personal computers, or other types of computing devices, such as an embedded computing device. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 1000 described below in the context of FIG. 4. In addition, the server 106 can include a Universal Asynchronous Receiver/Transmitter (UART), which is a type of “asynchronous receiver/transmitter.” A UART is a piece of computer hardware that translates data between parallel and serial forms. UARTs are commonly used in conjunction with communication standards such as EIA/RS-232. UARTs are now commonly included in microcontrollers. A related device, the universal synchronous and asynchronous receiver-transmitter (USART) also supports synchronous operation.

As shown in FIG. 1, the server 106 includes an audio input module 108, a keyword detection module 110, a speech-to-text (STT) conversion module 112, a natural language processing module 114, and a command module 116.

In some embodiments, the audio input module 108 is configured to receive an audio input, such as spoken audio from a pilot within the cockpit. In some embodiments, the audio input module 108 can be communicably coupled to a headset worn by the pilot and can receive the audio via the microphone therein. The audio input module 108 can be configured to configure received audio inputs, read the audio data, and detect human voice activity.

In some embodiments, the keyword detection module 110 is configured to detect one or more keywords within the received audio input. For example, the system 100 can have a certain word defined as the “keyword,” such as “Amelia.” The keyword detection module 110 is configured to process the audio input to infer/identify the spoken keyword. In response to detecting that the keyword has been spoken, the keyword detection module 110 can transmit an indication that causes the server device 106 to begin operating in interactive mode. In some embodiments, detecting the keyword can be performed probabilistically. For example, as audio frames are received, they can be placed into an internal audio frame buffer. If the buffer contains enough audio frame data to represent a full second of data, it will infer the presences of the keyword. If a keyword is detected with a probability above a preconfigured threshold value, then the interactive mode can be triggered.

In some embodiments, the STT conversion module 112 is configured to convert speech from an audio format to a textual format. The STT conversion module 112 can be configured to utilize an acoustic model with a specially trained neural network to analyze and understand audio in high-noise situations. For example, the training data used to train the model can include a pilot/aircraft domain-specific vocabulary. The training data set can be synthesized from a command set architecture for various types of aircraft, item phrases associated with their checklists, etc. In addition, the training data can be pre-processed through a digital audio workstation to allow for the addition of noise and other artifacts that replicate the quality of audio that would be received from an aircraft headset. Such pre-processing creates a training set that can be used to fine-tune the model for aircraft cockpit applications. In addition, the training data can include various acronyms used within aircraft control and management. In some embodiments, the STT conversion module 112 is configured to use an ASAPP SEW-D tiny model variant for acoustic modeling and a custom CTC beam search algorithm with language model scoring. In addition, a KenLM language model library can be used to facilitate fused language model scoring as beams are decoded. In some embodiments, other acoustic models that the STT conversion module 112 can utilize can include an OpenAI Whisper model and/or a UsefulSensors Moonshine model, although these are exemplary in nature. In addition, in some embodiments, other decoding algorithms that the STT conversion module 112 can utilize can include a greedy decoding algorithm and/or a transformed-based decoding model, although these are also exemplary in nature.

In some embodiments, the natural language processing module 114 is configured to analyze the text generated by the STT conversion module 112 to enable a common language interaction with the system. For example, the natural language processing module 114 can parse the text to determine an intent of the text. In some embodiments, the natural language processing module 114 can use a schema with a basic command syntax and data specifiers to extract user intent and specifications. In some embodiments, the natural language processing module 114 can use a phrase mapping file to apply string mapping to the STT output in cases where platform specific mappings are necessary.

In some embodiments, the command module 116 is configured to receive the determined intent and specifications from the natural language processing module 114 and package it into a structured command. The command module 116 can then transmit the structured command to the user device for additional processing.

As discussed above, the system 100 can employ BLE technology for wireless communication between devices, providing a secure and low power consumption solution for data transfer. The system 100 can also utilize JavaScript Object Notation (JSON) for data interchange, offering a lightweight and easy-to-parse format for both humans and machines. In some embodiments, the system 100 may incorporate a UART to translate data between parallel and serial forms, enabling efficient communication between different components of the system.

In some embodiments, the offline voice control system can utilize a single custom Generic Attribute Profile (GATT) service for data transfer between the server 106 and the user device 102. This GATT service can include GATT characteristics that work together to provide a simulated UART via BLE. This simulated UART can asynchronously stream duplex data of various lengths, facilitating efficient and flexible data communication. In some embodiments, the GATT service can be configured to support a single active connection at any given time. When not actively connected, the system can provide Generic Access Profile (GAP) advertisement as a peripheral device to available central devices. This allows the system to be discoverable and connectable by other devices, such as an iOS or iPadOS-based device. Further, in some embodiments, the GATT characteristics can be used to transmit data between the server 106 and the user device 102. For instance, one GATT characteristic can be used to transmit data from the server 106 to the user device 102, while the other GATT characteristic can be used to transmit data from the user device 102 to the server 106. This duplex data streaming capability can enable real-time voice control and response, enhancing the user experience and efficiency of checklist management and execution.

In some embodiments, JSON can be used for encoding the inter-device messaging protocol. This protocol may be used for communication between the server 106 and a user device 102. The protocol can be ASCII based text serialized in the JSON format, providing a standardized and efficient method for data interchange.

In some embodiments, the inter-device messaging protocol can include various types of messages, such as command messages, response messages, and status messages. Each message can include several fields, such as a type field indicating the message base type, an intent field indicating the intention of the message, a status field indicating the status or validity of the message, and a descriptors field containing any specifying data pertinent to the message. These fields can be encoded as ASCII strings in a JSON format, facilitating easy parsing and processing of the messages by the server 106 and the user device 102.

These features of the system, enabled by the use of UART and GATT characteristics, contribute to the system's ability to provide real-time, offline voice control for managing and executing aircraft checklists. The use of a simulated UART via BLE, in conjunction with the ability to handle varying data lengths, enhances the system's data communication capabilities, improving the overall user experience and effectiveness of the system 100.

In some embodiments, the system 100 can adapt its vocabulary to suit the user's checklist set, thereby enhancing the effectiveness and accessibility of the system. This adaptation can involve updating the server 106's on-device vocabulary to include the names of all available checklists stored within the user device 102. This feature can allow the system to accurately recognize and process voice commands pertaining to specific checklists, providing a personalized and efficient voice control experience for the user.

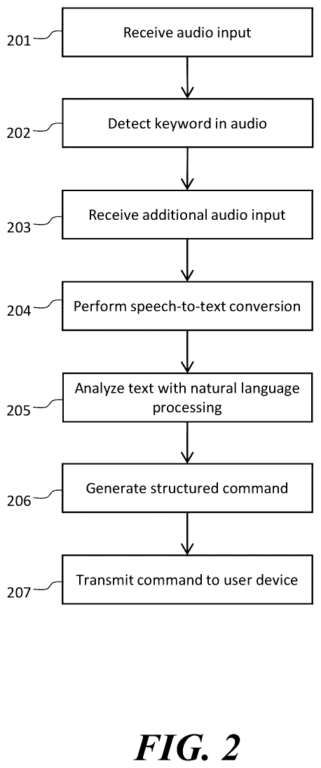

FIG. 2 is a flowchart of an example offline voice control process 200 according to example embodiments of the present disclosure. In some embodiments, process 200 can be performed by the server device 106 in conjunction with a user (i.e., a pilot) speaking in an attempt to access the voice control system, such as into the microphone over a headset.

At block 201, the audio input module 108 receives an audio input. In some embodiments, the audio input module 108 can analyze the audio input to detect the presence of a human voice. If no human voice is detected, then the process 200 may end, although the audio input module 108 can continue to monitor and receive audio inputs. However, in response to detecting human voice activity in the audio input, the audio input module 108 passes the audio input to the keyword detection module 110.

At block 202, the keyword detection module 110 detects a keyword in the audio input. The keyword can be pre-configured within the system 100. For example, the system 100 can have a certain word defined as the “keyword,” such as “Amelia.” The keyword detection module 110 is configured to process the audio input to infer/identify the spoken keyword, such as in a probabilistic manner. If a keyword is detected with a probability above a preconfigured threshold value, then the interactive mode can be triggered. As discussed above, once the interactive mode has been triggered, the server device 106 is configured to actively listen and analyze audio without first detecting the presence of a keyword. Moreover, various LED configurations can be illuminated to indicate to the user that interactive mode is engaged. In addition, if no additional audio is received within a certain time frame (e.g., two minutes), then the server device 106 can return to normal mode.

At block 203, while in interactive mode, the audio input module 108 receives an additional audio input. The audio input module 108 passes this input directly to the STT conversion module 112 for analysis. At block 204, the STT conversion module 112 performs a speech-to-text conversion on the audio input. In some embodiments, converting the audio input to a textual format (i.e., a textual message) can include analyzing the audio with an acoustic model that includes a specially trained neural network. As discussed in relation to FIG. 1, the acoustic model can be specifically trained to analyze and understand audio in high-noise (“noisy”) situations that simulate the environment within an aircraft cockpit. In addition, the acoustic model can have been trained on and fine-tuned with aircraft- and checklist-specific verbiage, as well as acronyms that are frequently used. After the audio has been converted to text, the STT conversion module 212 can pass the text to the natural language processing module 114.

At block 205, the natural language processing module 114 analyzes the text with natural language processing. In some embodiments, the natural language processing module 114 can parse the text to determine an intent of the text. In some embodiments, the natural language processing module 114 can use a schema with a basic command syntax and data specifiers to extract user intent and specifications. In other embodiments, the natural language processing module 114 can use a phrase mapping file that applies string mapping. For example, the intent can be various commands, such as to display a certain checklist, to change the checklist, to display all available checklists, to skip an item on a checklist, to complete an item on a checklist, to move forward/backward, etc.

At block 206, the command module 116 generates a structured command based on the results of the natural language processing module 114 that will, when processed, cause the user device 102 to perform the desired command. In some embodiments, the command module 116 can use specific message types for inter-device communication and sending structured commands. These message types may include, but are not limited to, remoteCommand, commandResponse, vocabRequest, vocabResponse, and deviceStatus. Each message type can have its own supported intents and descriptors, which can specify the action to be performed and the data associated with the action, respectively. For example, the remoteCommand message type can be used to emit voice control events or commands, while the commandResponse message type can be used to provide response information from the user device 102 to inform the server 106 on the success or failure of the remoteCommand previously sent. The use of specific message types for inter-device communication can facilitate efficient and accurate data exchange between the server 106 and the user device 102, enhancing the overall functionality and performance of the system. In some embodiments, the server 106 can use a specific format for message data termination. For instance, the server 106 can use an ASCII termination string, such as “$$$”, to end-cap messages. This termination string can be used to parse multiple messages from a single receive buffer, facilitating efficient and accurate data communication. An example message server 106 can be formatted as follows: “$$$$$$”, where “ ” represents the contents of the message. This specific format for message data termination server 106 can contribute to the reliable and secure data transfer capabilities of the system, enhancing the overall user experience and effectiveness of the system. At block 207, the command module 116 transmits the command to the user device 102, such as via a BLE co-processor.

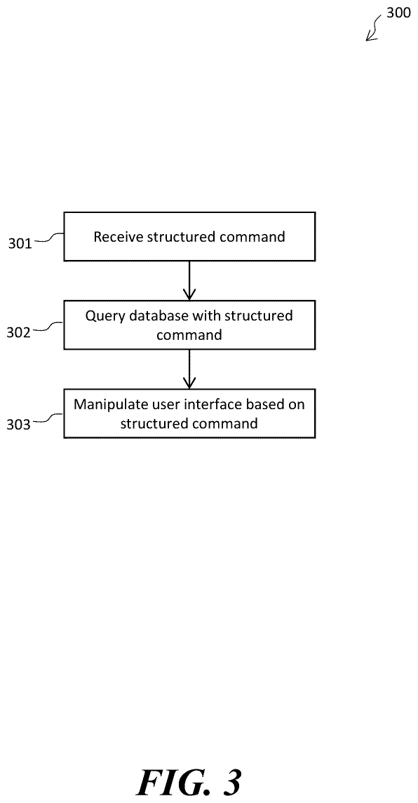

FIG. 3 is another flowchart of an example offline voice control process 300 according to example embodiments of the present disclosure. In some embodiments, the process 300 can be performed by the user device 102 via the UI 120. For example, the process 300 can be performed after the completion of process 200 in conjunction with a user (i.e., a pilot) speaking in an attempt to access the voice control system, such as into the microphone over a headset. At block 301, the user device 102 receives a structured command from the server device 106. For example, the user device 102 can receive the structured command via BLE.

At block 302, the user device 102 queries the database 122 with the structured command. For example, the querying can identify specific actions associated with the digitized checklists stored within the database 122. At block 303, the user device 102 manipulates the UI 120 based on the structured command. For example, the user device can move from one list to another displayed on the UI 120, display all checklists, or provide an indication of what a current item of the checklist is, such as by highlighting.

In some embodiments, the UI 120 can be used for the display, completion, and modification of aircraft checklists. The UI 120 can be part of a companion application, such as the Innovative Checklist application, that is compatible with the user device 102. The UI 120 can allow pilots to interact with the checklists in a convenient and intuitive manner, thereby enhancing the user experience and efficiency of checklist management and execution. In particular, the UI 120 can provide various functionalities for checklist navigation and item management. For instance, the UI 120 can allow pilots to navigate through the items of a checklist, mark items as complete, skip items, or move back to previous items. The UI 120 can also provide functionalities for advancing to the next checklist, displaying all available checklists, and updating checklist items via voice commands. These functionalities can contribute to the overall efficiency and accuracy of managing and executing aircraft checklists.

In addition, in some embodiments, users can (via speaking commands to the server device 106 and the user device 102 processing the resulting structured commands) switch between different aircraft and their corresponding checklists, providing flexibility and adaptability in various flight scenarios. The UI 120 can also allow for the creation and modification of checklists, enabling pilots to customize the checklists according to their specific requirements or preferences.

In addition, example manipulations of the UI 120 are described with respect to FIGS. 4-9.

FIGS. 4-9 show example user interfaces within a voice control application according to some embodiments of the present disclosure. For example, the UI 400 in FIG. 4 includes two example checklists for a DA62 (v3.2) aircraft. The UI 400 includes a list 401 of preflight items and a list 402 of normal items. In some embodiments, the various lists can be separated in space within the UI 400 and can be color coded to indicate the type of checklist. For example, preflight checklist items can be blue normal checklist items can be white, abnormal checklist items can be yellow, and emergency checklist items can be red.

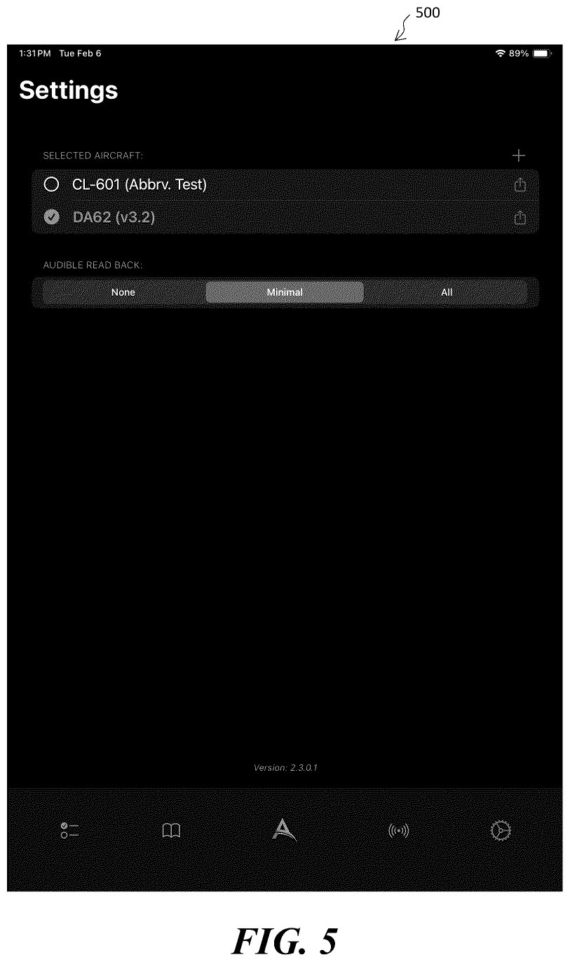

The UI 500 of FIG. 5, when displayed on the user device 102, allows the user to select the type of aircraft and thus the checklist that will be displayed. For example, as discussed previously, different aircrafts generally have different OEM checklists. These can be accessed in a digitized format via the database 122. When a user selects a different type of aircraft via the UI 500, a new checklist will be obtained from the database 122 and displayed.

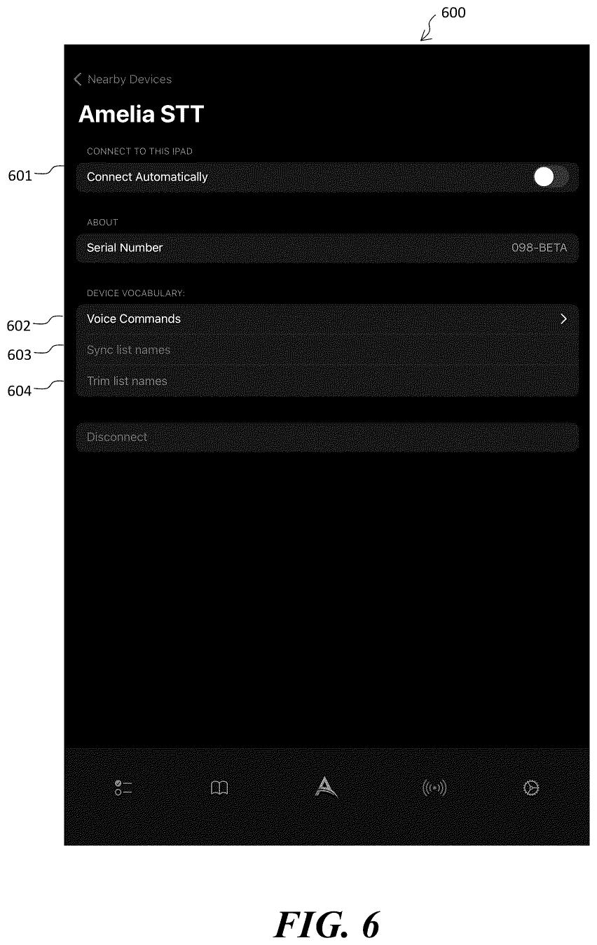

The UI 600 of FIG. 6 provides various connectivity options to the user. For example, the UI 600 includes an option 601 that control the behavior of automatically initiating a Bluetooth® connection with this unit serial number upon launch of the application on the user device 102. In addition, option 602 allows the user to access a list of currently existing voice commands. Option 603 allows the user to sync a list of names that can be added to the system. For example, the device vocabulary allows for interrogation/manipulation of the model contained within the STT conversion module 112 of the server 106. Option 604 allows the user to trim or remove names from the on-device (user device 102) vocabulary used during decoding.

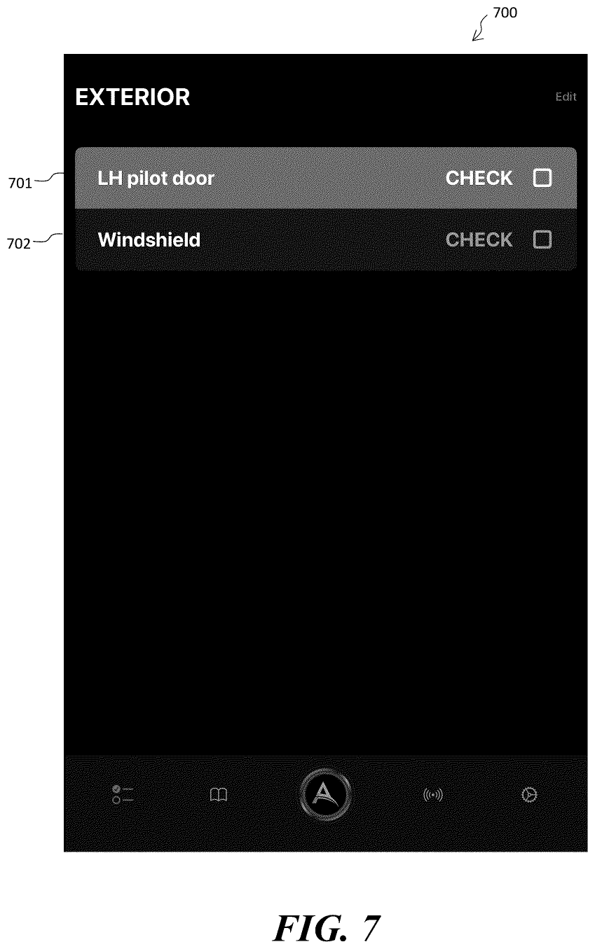

The UI 700 of FIG. 7 displays an example exterior checklist for an aircraft and includes two tasks that must be completed, task 701 that includes the left-hand pilot door and task 702 that includes the windshield. The task 701 can be highlighted to indicate it is the current item to be completed. In order to mark it checked, the user can verbally identify the task 702 and mark it “complete” or verbally indicate “check.” In response to the server 106 receiving this audio message while in interactive mode, the message is converted into a structural command (see FIG. 2). The command is then received by the user device 102 and processed accordingly (see FIG. 3). Once the command is processed, the task 701 is checked and marked complete. In another example, the user could verbally indicate “skip” and the item 702 would be highlighted instead.

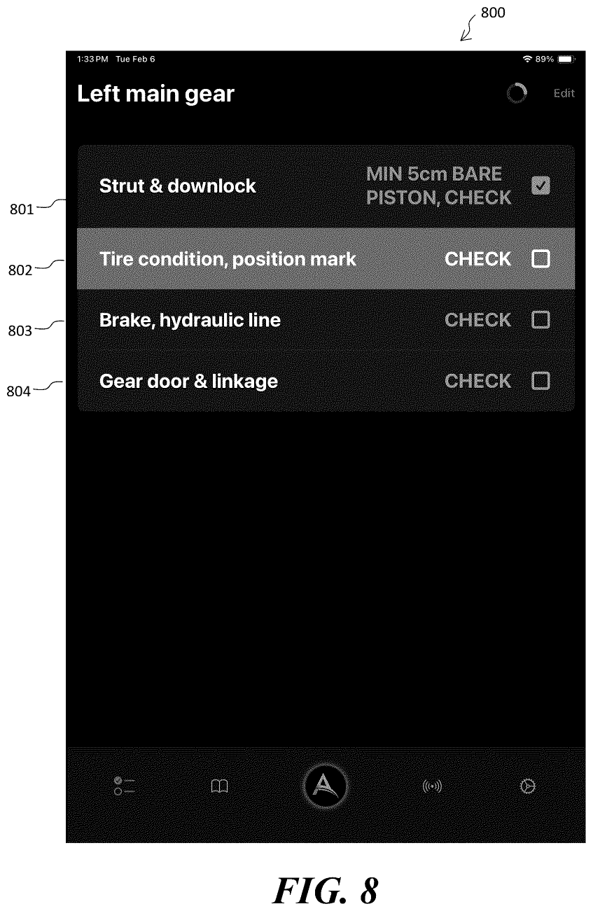

The UI 800 of FIG. 8, similar to FIG. 7, displays an example left main gear checklist for an aircraft. The UI 800 includes a completed task 801 (strut & downlock), a current task 802 (tire condition, position mark), and two subsequent but incomplete tasks: task 803 (brake, hydraulic line) and task 804 (gear door & linkage).

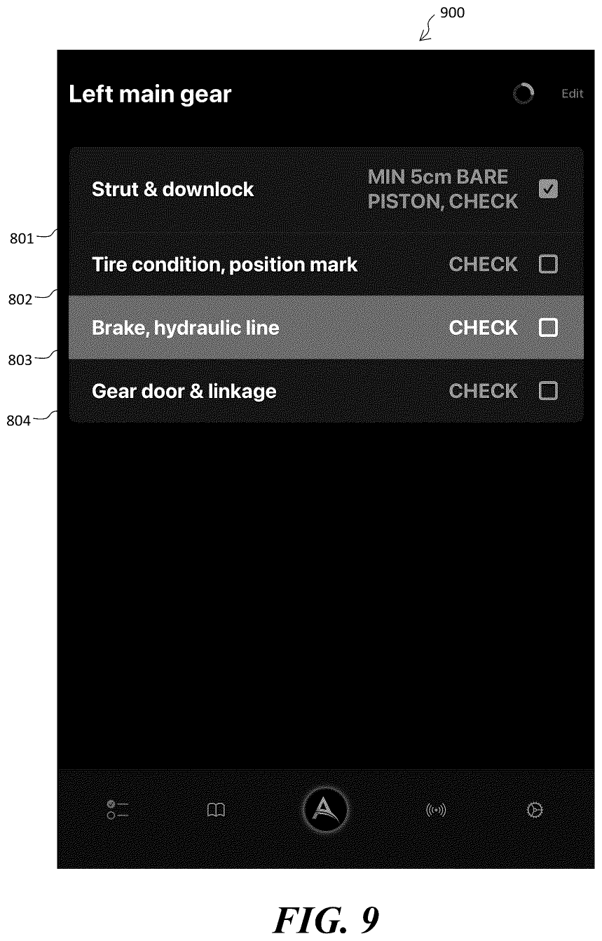

The UI 900 of FIG. 9 displays an example left main gear checklist for an aircraft, the same checklist displayed in FIG. 8. When the UI 800 is displayed on the user device and the user verbally indicates “skip,” the current task can move from task 802 to task 803.

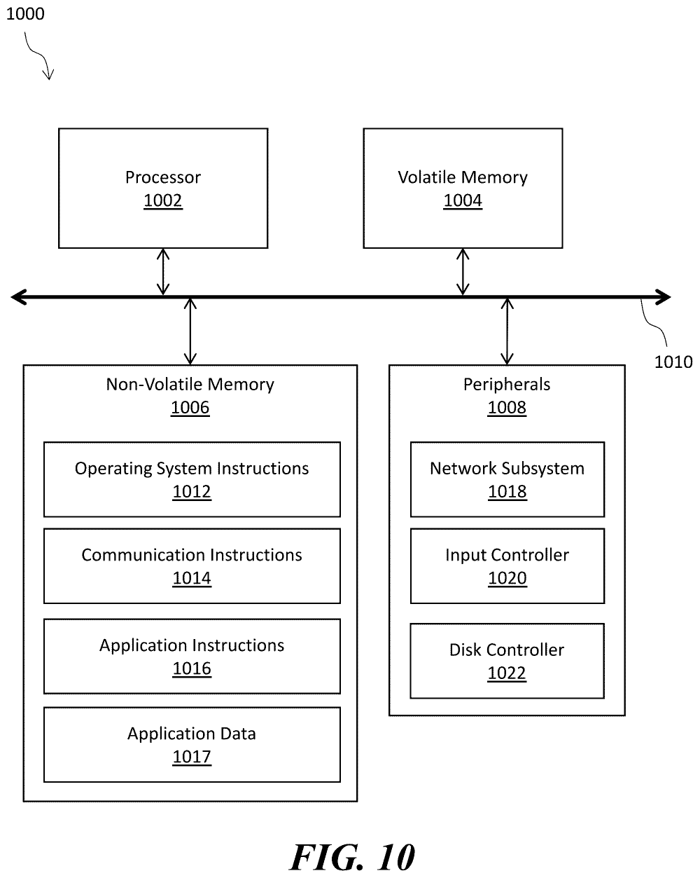

FIG. 10 is a diagram of an example server device 1000 that can be used within system 100 of FIG. 1. Server device 1000 can implement various features and processes as described herein. Server device 1000 can be implemented on any electronic device that runs software applications derived from complied instructions, including without limitation personal computers, servers, smart phones, media players, electronic tablets, game consoles, email devices, etc. In some implementations, server device 1000 can include one or more processors 1002, volatile memory 1004, non-volatile memory 1006, and one or more peripherals 1008. These components can be interconnected by one or more computer buses 1010.

Processor(s) 1002 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 1010 can be any known internal or external bus technology, including but not limited to ISA, EISA, PCI, PCI Express, USB, Serial ATA, or Fire Wire. Volatile memory 1004 can include, for example, SDRAM. Processor 1002 can receive instructions and data from a read-only memory or a random access memory or both. Essential elements of a computer can include a processor for executing instructions and one or more memories for storing instructions and data.

Non-volatile memory 1006 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 1006 can store various computer instructions including operating system instructions 1012, communication instructions 1014, application instructions 1016, and application data 1017. Operating system instructions 1012 can include instructions for implementing an operating system (e.g., Mac OS®, Windows®, or Linux). The operating system can be multi-user, multiprocessing, multitasking, multithreading, real-time, and the like. Communication instructions 1014 can include network communications instructions, for example, software for implementing communication protocols, such as TCP/IP, HTTP, Ethernet, telephony, etc. Application instructions 1016 can include instructions for various applications. Application data 1017 can include data corresponding to the applications.

Peripherals 1008 can be included within server device 1000 or operatively coupled to communicate with server device 1000. Peripherals 1008 can include, for example, network subsystem 1018, input controller 1020, and disk controller 1022. Network subsystem 1018 can include, for example, an Ethernet of WiFi adapter. Input controller 1020 can be any known input device technology, including but not limited to a keyboard (including a virtual keyboard), mouse, track ball, and touch-sensitive pad or display. Disk controller 1022 can include one or more mass storage devices for storing data files; such devices include magnetic disks, such as internal hard disks and removable disks; magneto-optical disks; and optical disks.

FIG. 11 is an example computing device that can be used within the system 100 of FIG. 1, according to an embodiment of the present disclosure. In some embodiments, device 1100 can be user device 102. The illustrative user device 1100 can include a memory interface 1102, one or more data processors, image processors, central processing units 1104, and or secure processing units 1105, and peripherals subsystem 1106. Memory interface 1102, one or more central processing units 1104 and or secure processing units 1105, and or peripherals subsystem 1106 can be separate components or can be integrated in one or more integrated circuits. The various components in user device 1100 can be coupled by one or more communication buses or signal lines.

Sensors, devices, and subsystems can be coupled to peripherals subsystem 1106 to facilitate multiple functionalities. For example, motion sensor 1110, light sensor 1112, and proximity sensor 1114 can be coupled to peripherals subsystem 1106 to facilitate orientation, lighting, and proximity functions. Other sensors 1116 can also be connected to peripherals subsystem 1106, such as a global navigation satellite system (GNSS) (e.g., GPS receiver), a temperature sensor, a biometric sensor, magnetometer, or other sensing device, to facilitate related functionalities.

Camera subsystem 1120 and optical sensor 1122, e.g., a charged coupled device (CCD) or a complementary metal-oxide semiconductor (CMOS) optical sensor, can be utilized to facilitate camera functions, such as recording photographs and video clips. Camera subsystem 1120 and optical sensor 1122 can be used to collect images of a user to be used during authentication of a user, e.g., by performing facial recognition analysis.

Communication functions can be facilitated through one or more wired and or wireless communication subsystems 1124, which can include radio frequency receivers and transmitters and or optical (e.g., infrared) receivers and transmitters. For example, the Bluetooth (e.g., BLE) and or WiFi communications described herein can be handled by wireless communication subsystems 1124. The specific design and implementation of communication subsystems 1124 can depend on the communication network(s) over which the user device 1100 is intended to operate. For example, user device 1100 can include communication subsystems 1124 designed to operate over a GSM network, a GPRS network, an EDGE network, a WiFi or WiMax network, and a Bluetooth™ network. For example, wireless communication subsystems 1124 can include hosting protocols such that device 1100 can be configured as a base station for other wireless devices and or to provide a WiFi service.

Audio subsystem 1126 can be coupled to speaker 1128 and microphone 1130 to facilitate voice-enabled functions, such as speaker recognition, voice replication, digital recording, and telephony functions. Audio subsystem 1126 can be configured to facilitate processing voice commands, voice-printing, and voice authentication, for example.

I/O subsystem 1140 can include a touch-surface controller 1142 and or other input controller(s) 1144. Touch-surface controller 1142 can be coupled to a touch-surface 1146. Touch-surface 1146 and touch-surface controller 1142 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1146.

The other input controller(s) 1144 can be coupled to other input/control devices 1148, such as one or more buttons, rocker switches, thumb-wheel, infrared port, USB port, and or a pointer device such as a stylus. The one or more buttons (not shown) can include an up/down button for volume control of speaker 1128 and or microphone 1130.

In some implementations, a pressing of the button for a first duration can disengage a lock of touch-surface 1146; and a pressing of the button for a second duration that is longer than the first duration can turn power to user device 1100 on or off. Pressing the button for a third duration can activate a voice control, or voice command, module that enables the user to speak commands into microphone 1130 to cause the device to execute the spoken command. The user can customize a functionality of one or more of the buttons. Touch-surface 1146 can, for example, also be used to implement virtual or soft buttons and or a keyboard.

In some implementations, user device 1100 can present recorded audio and or video files, such as MP3, AAC, and MPEG files. In some implementations, user device 1100 can include the functionality of an MP3 player, such as an iPod™. User device 1100 can, therefore, include a 36-pin connector and or 8-pin connector that is compatible with the iPod. Other input/output and control devices can also be used.

Memory interface 1102 can be coupled to memory 1150. Memory 1150 can include high-speed random access memory and or non-volatile memory, such as one or more magnetic disk storage devices, one or more optical storage devices, and or flash memory (e.g., NAND, NOR). Memory 1150 can store an operating system 1152, such as Darwin, RTXC, LINUX, UNIX, OS X, Windows, or an embedded operating system such as VxWorks.

Operating system 1152 can include instructions for handling basic system services and for performing hardware dependent tasks. In some implementations, operating system 1152 can be a kernel (e.g., UNIX kernel). In some implementations, operating system 1152 can include instructions for performing voice authentication.

Memory 1150 can also store communication instructions 1154 to facilitate communicating with one or more additional devices, one or more computers and or one or more servers. Memory 1150 can include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic messaging-related process and functions; web browsing instructions 1164 to facilitate web browsing-related processes and functions; media processing instructions 1166 to facilitate media processing-related functions and processes; GNSS/Navigation instructions 1168 to facilitate GNSS and navigation-related processes and instructions; and or camera instructions 1170 to facilitate camera-related processes and functions.

Memory 1150 can store application (or “app”) instructions and data 1172, such as instructions for the apps described above in the context of FIGS. 1-3. Memory 1150 can also store other software instructions 1174 for various other software applications in place on device 400. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an application programming interface (API). An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A computing system comprising:
a processor; and
a non-transitory computer-readable storage device storing computer-executable instructions, the instructions operable to cause the processor to perform operations comprising:
receiving an audio input;
converting the audio input to a textual message;
analyzing the textual message with a natural language processing technique to identify an intent;
generating a structured command based on the identified intent; and
transmitting the structured command to a user device.

2. The computing system of claim 1, wherein the operations comprise, prior to receiving the audio input:
receiving an initial audio input; and
detecting a predefined keyword in the initial audio input.

3. The computing system of claim 2, wherein detecting a predefined keyword in the initial audio input comprises processing the audio input to infer a probability of a keyword.

4. The computing system of claim 3, wherein detecting a predefined keyword in the initial audio input comprises identifying an inferred word with a probability greater than a predefined threshold.

5. The computing system of claim 1, wherein converting the audio input to the textual message comprises analyzing the audio input with an acoustic model comprising a neural network trained on high-noise audio samples.

6. The computing system of claim 5, wherein the neural network is fine-tuned with a plurality of keywords associated with aircraft.

7. The computing system of claim 1, wherein analyzing the textual message with the natural language processing technique to identify the intent comprises parsing text within the textual message to determine the intent.

8. The computing system of claim 1, wherein analyzing the textual message with the natural language processing technique to identify the intent comprises applying a predefined schema comprising a command syntax to extract the intent.

9. The computing system of claim 1, wherein analyzing the textual message with the natural language processing technique to identify the intent comprises applying a phrase mapping file to the textual message.

10. The computing system of claim 1, wherein analyzing the textual message with the natural language processing technique to identify the intent comprises applying a phrase mapping file to the textual message.

11. A computer-implemented method, performed by at least one processor, comprising:
receiving an audio input;
converting the audio input to a textual message;
analyzing the textual message with a natural language processing technique to identify an intent;
generating a structured command based on the identified intent; and
transmitting the structured command to a user device.

12. The computer-implemented method of claim 11 comprising, prior to receiving the audio input:
receiving an initial audio input; and
detecting a predefined keyword in the initial audio input.

13. The computer-implemented method of claim 12, wherein detecting a predefined keyword in the initial audio input comprises processing the audio input to infer a probability of a keyword.

14. The computer-implemented method of claim 13, wherein detecting a predefined keyword in the initial audio input comprises identifying an inferred word with a probability greater than a predefined threshold.

15. The computer-implemented method of claim 11, wherein converting the audio input to the textual message comprises analyzing the audio input with an acoustic model comprising a neural network trained on high-noise audio samples.

16. The computer-implemented method of claim 15, wherein the neural network is fine-tuned with a plurality of keywords associated with aircraft.

17. The computer-implemented method of claim 11, wherein analyzing the textual message with the natural language processing technique to identify the intent comprises parsing text within the textual message to determine the intent.

18. The computer-implemented method of claim 11, wherein analyzing the textual message with the natural language processing technique to identify the intent comprises applying a predefined schema comprising a command syntax to extract the intent.

19. The computer-implemented method of claim 11, wherein analyzing the textual message with the natural language processing technique to identify the intent comprises applying a phrase mapping file to the textual message.

20. The computer-implemented method of claim 11, wherein analyzing the textual message with the natural language processing technique to identify the intent comprises applying a phrase mapping file to the textual message.
